(19) United States
(12) Patent Application Publication
(10) Pub. No.: US 2026/0135038 A1
(43) Pub. Date: May 14, 2026

(54) MULTILAYER CERAMIC CAPACITOR

(71) Applicant: SAMSUNG ELECTRO-MECHANICS CO., LTD., Suwon-si (KR)

(72) Inventors: Sungsoo Kim, Suwon-si (KR); Heejung Jung, Suwon-si (KR); Junil Kang, Suwon-si (KR); Cheong Kim, Suwon-si (KR); Chungyeol Lee, Suwon-si (KR); Seungjin Park, Suwon-si (KR); Jaeyoung Na, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/089,747

(22) Filed: Mar. 25, 2025

(30) Foreign Application Priority Data
Nov. 13, 2024 (KR) 10-2024-0160907

(51) Int. Cl. H01G 4/232; H01G 4/12; H01G 4/248; H01G 4/30

(52) U.S. Cl. CPC H01G 4/2325; H01G 4/12; H01G 4/248; H01G 4/30

(57) ABSTRACT

A multilayer ceramic capacitor according to an embodiment includes: a body including a plurality of internal electrodes stacked with a dielectric layer interposed therebetween; and an external electrode disposed outside the body and connected to the plurality of internal electrodes, wherein the external electrode includes a first plating layer, an average ratio of a major axis and a minor axis of a crystal grain of the first plating layer is 1:1 or more and 3:1 or less, and a coefficient of variation of a thickness of the first plating layer is 11.7% or more and 15.9% or less.

### CROSS-REFERENCE TO RELATED APPLICATION

This application claims priority to and the benefit of Korean Patent Application No. 10-2024-0160907 filed with the Korean Intellectual Property Office on Nov. 13, 2024, the entire contents of which are incorporated herein by reference.

### BACKGROUND

### 1. Field

The present disclosure relates to a multilayer ceramic capacitor.

### 2. Description of the Related Art

An electronic component that uses a ceramic material include a capacitor, an inductor, a piezoelectric element, a varistor, or a thermistor. Among these ceramic electronic components, a multilayer ceramic capacitor (MLCC) may be used in various electronic devices due to its merits of being small, ensuring high capacity, and being easy to mount.

The multilayer ceramic capacitor may include a body including a plurality of dielectric layers and a plurality of internal electrodes, and an external electrode disposed outside the body and connected to the internal electrode. If hydrogen generated during a plating process penetrates into the interior of the multilayer ceramic capacitor, the insulation resistance may be deteriorated. In addition, technologies that can improve the thickness distribution and surface roughness of the plating layer are needed.

### SUMMARY

One aspect of the embodiment is to provide a multilayer ceramic capacitor that can prevent insulation resistance deterioration.

Another aspect of the embodiment is to provide a multilayer ceramic capacitor that can improve the thickness distribution and surface roughness of the plating layer.

A multilayer ceramic capacitor according to an embodiment includes: a body including a plurality of internal electrodes stacked with a dielectric layer interposed therebetween; and an external electrode disposed outside the body and connected to the plurality of internal electrodes, wherein the external electrode includes a first plating layer, an average ratio of a major axis and a minor axis of a crystal grain of the first plating layer may be 1:1 or more and 3:1 or less, and a coefficient of variation of a thickness of the first plating layer may be 11.7% or more and 15.9% or less.

An average thickness of the first plating layer may be 1.806 μm or more and 2.2362 μm or less.

A standard deviation of the thickness of the first plating layer may be 0.24 or more and 0.35 or less.

The first plating layer may contain nickel (Ni).

The major axis of the crystal grain may represent a maximum dimension of the crystal grain, and the minor axis may represent a maximum dimension measured in a direction that is perpendicular to a measurement direction of the major axis.

The multilayer ceramic capacitor may further include a second plating layer disposed on the first plating layer.

The second plating layer may contain tin (Sn).

The external electrode may further include an electrode layer disposed between the body and the first plating layer and connected to the internal electrode.

A multilayer ceramic capacitor according to some embodiments of the present disclosure includes: a body including a plurality of internal electrodes stacked with a dielectric layer interposed therebetween; and an external electrode disposed outside the body and connected to the plurality of internal electrodes, wherein the external electrode includes a first plating layer, an average ratio of a major axis and a minor axis of a crystal grain of the first plating layer may be 1:1 or more and 3:1 or less, and a surface roughness of the first plating layer may be 1.51 μm or more and 1.86 μm or less.

The first plating layer may contain nickel (Ni).

The major of the crystal grain may represent a maximum dimension of the crystal grain, and the minor axis may represent a maximum dimension measured in a direction that is perpendicular to a measurement direction of the major axis.

The multilayer ceramic capacitor may further include a second plating layer disposed on the first plating layer.

The second plating layer may contain tin (Sn).

The external electrode may further include an electrode layer disposed between the body and the first plating layer and connected to the internal electrode.

According to the multilayer ceramic capacitor according to some embodiments of the present disclosure, insulation resistance deterioration can be prevented by controlling the ratio of the major and minor axes of the crystal grains of the plating layer of the external electrode.

In addition, in the multilayer ceramic capacitor according to the embodiments, the thickness distribution and surface roughness of the plating layer can be improved by controlling the ratio of the major and minor axes of the crystal grains of the plating layer of the external electrode.

### BRIEF DESCRIPTION OF THE DRAWINGS

FIG. 1 is a schematic perspective view of a multilayer ceramic capacitor according to an embodiment.

FIG. 2 is an exploded perspective view that schematically shows a stacking structure of internal electrodes of the multilayer ceramic capacitor of FIG. 1.

FIG. 3 is a schematic plan of a first internal electrode of the multilayer ceramic capacitor of FIG. 1.

FIG. 4 is a schematic plan view of a second internal electrode of the multilayer ceramic capacitor of FIG. 1.

FIG. 5 is a cross-sectional view taken along line I-I′ in FIG. 1.

FIG. 6 is a cross-sectional view taken along line II-II′ in FIG. 1.

FIG. 7 is an enlarged cross-sectional view of region A in FIG. 5.

FIG. 8 is a schematic view of a current application profile of a direct current (DC) plating method.

FIG. 9 is a schematic view showing the current application profile of a pulse periodic reverse current plating method.

FIG. 10 is an electron microscope photograph of a first plating layer formed by the PPR plating method.

FIG. 11 an electron microscope photograph of a first plating layer formed by the DC plating method.

FIG. 12 is a schematic view that shows a plating layer smoothing process by PPR plating.

FIG. 13 is a graph that show results of an insulation resistance reliability evaluation at high temperatures for a multilayer ceramic capacitor according to Example and Comparative Example.

FIG. 14 is a graph that shows results of evaluating the thickness uniformity of a plating layer for a multilayer ceramic capacitor according to Example and Comparative Example.

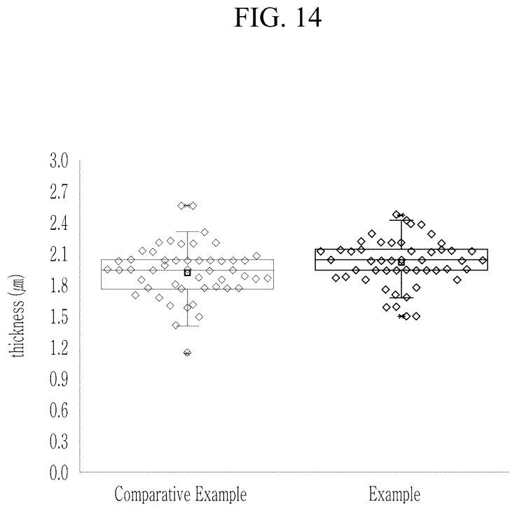

### DETAILED DESCRIPTION

Hereinafter, with reference to the accompanying drawing, an embodiment is described in detail such that a person of ordinary skill in the art to which the present disclosure belongs can easily carry out the present disclosure. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

Throughout the specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise,” and variations such as “comprises” or “comprising,” will be understood to imply the inclusion of stated elements but not the exclusion of any other elements.

Further, throughout the specification, when it is referred to as “on a plane,” it means when a target part is viewed from above, and when it is referred to as “on a cross-section”, it means when the cross section obtained by cutting a target part vertically is viewed from the side.

Further, throughout the specification, when it is referred to as “connected,” this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

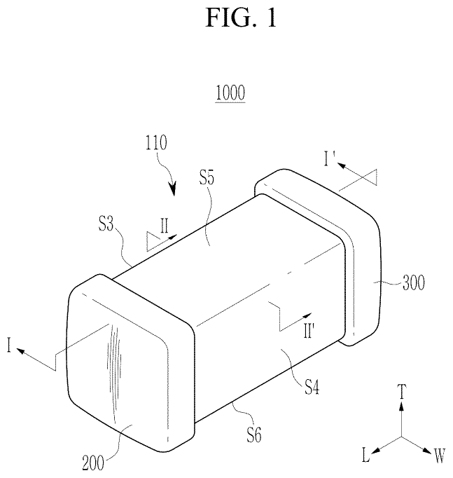

FIG. 1 is a schematic perspective view of a multilayer ceramic capacitor according to an embodiment.

Referring to FIG. 1, a multilayer ceramic capacitor 1000 according to the present embodiment includes a body 110, a first external electrode 200, and a second external electrode 300.

First, to clearly explain the present embodiment, directions will be defined as follows: the L-axis, W-axis, and T-axis shown in the drawing represent a first direction, a second direction, and a third direction of the multilayer ceramic capacitor 1000, respectively.

The first direction (L-axis direction) is a direction parallel to a wide surface (main surface) of components having a sheet shape, and may be a direction that intersects (or is orthogonal to) the third direction (T-axis direction). For example, the first direction (L-axis direction) may be a direction in which the first external electrode 200 and the second external electrode 300 oppose each other. Hereinafter, for better understanding and ease of description, the “first direction” will be referred to as a “length direction.”

The second direction (W-axis direction) is a direction parallel to a wide surface (main surface) of components having a sheet shape, and may be a direction that simultaneously intersects (or is orthogonal to) the first direction (L-axis direction) and the third direction (T-axis direction). Hereinafter, for better understanding and ease of description, the “second direction” will be referred to as a “width direction.”

The third direction (T-axis direction) may be a direction perpendicular to a wide surface (main surface) of components having a sheet shape. For example, the third direction (T-axis direction) may be used as the same concept as a direction in which dielectric layers 140 are stacked. Hereinafter, for better understanding and ease of description, the “third direction” will be referred to as a “thickness direction.”

The body 110 may have a substantially hexahedral shape, but the present embodiment is not limited thereto. Due to shrinkage during sintering, the body 110 may have a substantially hexahedral shape, although not a fully hexahedral shape. For example, the body 110 may have a substantially rectangular hexahedral shape, but corner or vertex portions may have a round shape.

In the present embodiment, for convenience of description, surfaces of the body 110 that oppose each other in the length direction (L-axis direction) are defined as a first surface S1 and a second surface S2, surfaces of the body 110 that oppose each other in the width direction (W-axis direction) are defined as a third surface S3 and a fourth surface S4, surfaces of the body 110 that oppose each other in the thickness direction (T-axis direction) are defined as a fifth surface S5 and a sixth surface S6.

Accordingly, the first direction in which the first surface S1 and the second surface S2 oppose each other, may be the length direction (L-axis direction), and the second direction and the third direction, which are perpendicular to the first direction and perpendicular to each other, may be the thickness direction (T-axis direction) and the width direction (W-axis direction) or the width direction (W-axis direction) and the thickness direction (T-axis direction), respectively.

A length of the body 110 may refer to, based on an optical microscope or scanning electron microscope (SEM) photograph of a cross-section taken along the length direction (L-axis direction)-the thickness direction (T-axis direction) at a center of the body 110 in the width direction (W-axis direction), a maximum value of lengths of a plurality of line segments that connect two outermost boundary lines facing each other in the length direction (L-axis direction) of the body 110 shown in the above cross-sectional photograph and are parallel to the length direction (L-axis direction). Meanwhile, the length of the body 110 may refer to a minimum value of lengths of a plurality of line segments that connect two outermost boundary lines facing each other in the length direction (L-axis direction) of the body 110 shown in the above cross-sectional photograph and are parallel to the length direction (L-axis direction). On the other hand, the length of the body 110 may refer to an arithmetic mean value of lengths of at least two of a plurality of line segments that connect two outermost boundary lines facing each other in the length direction (L-axis direction) of the body 110 shown in the above cross-sectional photograph and are parallel to the length direction (L-axis direction). The length of the body 110 may be measured by a standard method that will be apparent to and understood by one of ordinary skill in the art.

A thickness of the body 110 may refer to, based on an optical microscope or scanning electron microscope (microscope SEM) photograph of a cross-section taken along the length direction (L-axis direction)-the thickness direction (T-axis direction) at a center of the body 110 in the width direction (W-axis direction), a maximum value of lengths of a plurality of line segments that connect two outermost boundary lines facing each other in the thickness direction (T-axis direction) of the body 110 shown in the above cross-sectional photograph and are parallel to the thickness direction (T-axis direction). Meanwhile, the thickness of the body 110 may refer to a minimum value of lengths of a plurality of line segments that connect two outermost boundary lines facing each other in the thickness direction (T-axis direction) of the body 110 shown in the above cross-sectional photograph and are parallel to the thickness direction (T-axis direction). On the other hand, the thickness of the body 110 may refer to an arithmetic mean value of lengths of at least two of a plurality of line segments that connect two outermost boundary lines facing each other in the thickness direction (T-axis direction) of the body 110 shown in the above cross-sectional photograph and are parallel to the thickness direction (T-axis direction). The thickness of the body 110 may be measured by a standard method that will be apparent to and understood by one of ordinary skill in the art.

A width of the body 110 may refer to, based on an optical microscope or scanning electron microscope (microscope SEM) photograph of a cross-section taken along the length direction (L-axis direction)-the width direction (W-axis direction) at a center of the body 110 in the thickness direction (T-axis direction), a maximum value of lengths of a plurality of line segments that connect two outermost boundary lines facing each other in the width direction (W-axis direction) of the body 110 shown in the above cross-sectional photograph and are parallel to the width direction (W-axis direction). Meanwhile, the width of the body 110 may refer to a minimum value of lengths of a plurality of line segments that connect two outermost boundary lines facing each other in the width direction (W-axis direction) of the body 110 shown in the above cross-sectional photograph and are parallel to the width direction (W-axis direction). On the other hand, the width of the body 110 may refer to an arithmetic mean value of lengths of at least two of a plurality of line segments that connect two outermost boundary lines facing each other in the width direction (W-axis direction) of the body 110 shown in the above cross-sectional photograph and are parallel to the width direction (W-axis direction). The width of the body 110 may be measured by a standard method that will be apparent to and understood by one of ordinary skill in the art.

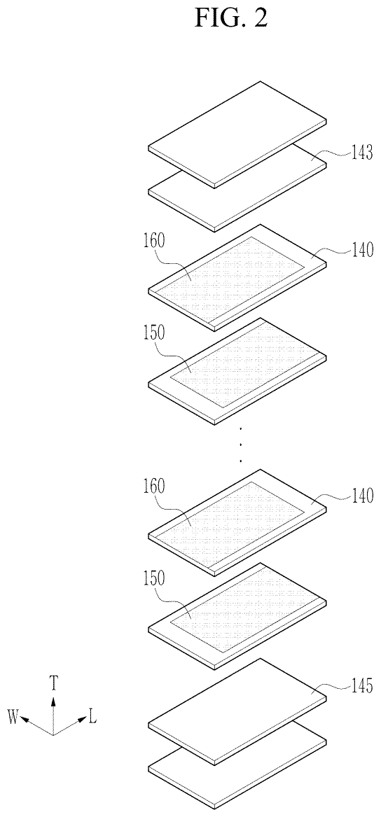

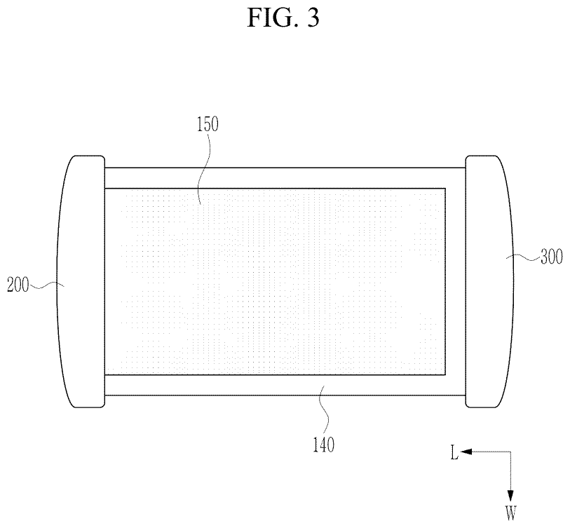

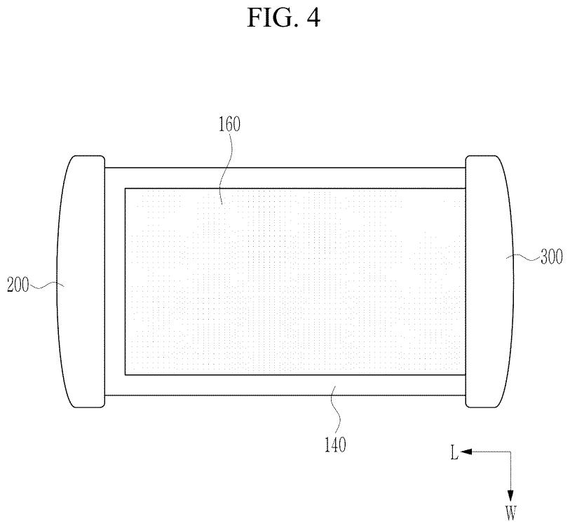

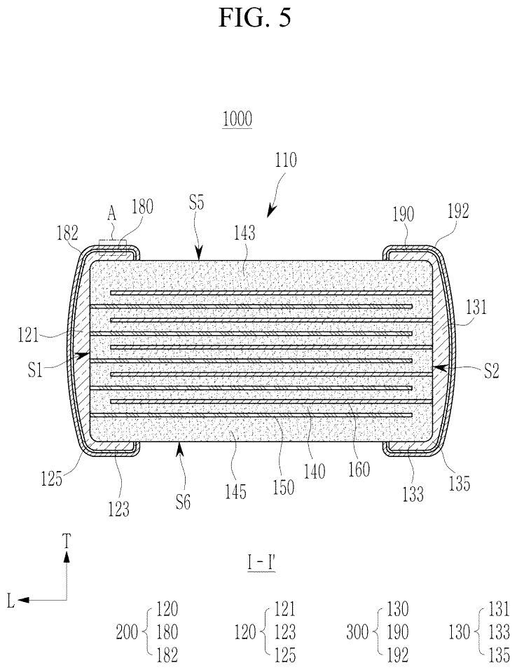

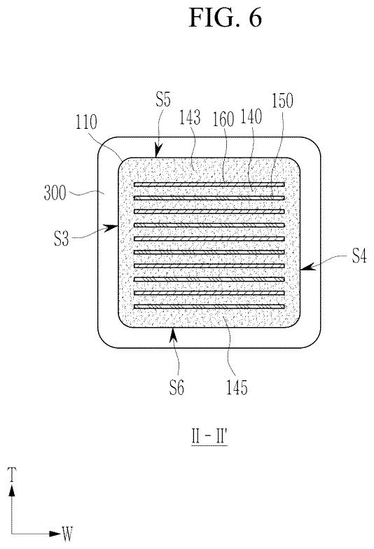

FIG. 2 is an exploded perspective view that schematically shows a stacking structure of the multilayer ceramic capacitor of FIG. 1, FIG. 3 is a schematic top plan of a first internal electrode of the multilayer ceramic capacitor of FIG. 1, and FIG. 4 is a schematic top plan view of a second internal electrode of the multilayer ceramic capacitor of FIG. 1. FIG. 5 is a cross-sectional view taken along line I-I′ in FIG. 1, and FIG. 6 is a cross-sectional view taken along line II-II′ in FIG. 1.

Referring to FIG. 2, FIG. 3, FIG. 4, FIG. 5, and FIG. 6, the body 110 may include a plurality of dielectric layers 140, a first internal electrode 150, and a second internal electrode 160.

A plurality of dielectric layers 140 are stacked in the thickness direction (T-axis direction) of the body 110. Boundaries between the dielectric layers 140 may be unclear. For example, the boundary between the dielectric layers 140 may be difficult to confirm without using a scanning electron microscope (SEM), and the plurality of dielectric layers 140 may appear to be an integral structure.

The dielectric layer 140 may include a ceramic material. For example, the ceramic material may include a dielectric ceramic including a component such as at least one selected from the group consisting of BaTiO₃, CaTiO₃, SrTiO₃, and CaZrO₃. In addition, the ceramic material may further include auxiliary components such as at least one selected from the group consisting of a manganese (Mn) compound, an iron (Fe) compound, a chromium (Cr) compound, a cobalt (Co) compound, and a nickel (Ni) compound in addition to the above-mentioned component. For example, the dielectric layer may include at least one selected from the group consisting of (Ba₁₋ₓCaₓ)TiO₃ (0<x<1), (Ba₁₋ₓCaₓ)TiO₃ (0<x<1), Ba (Ti_{1-y}Ca_{y})O₃ (0<y<1), (Ba₁₋ₓCaₓ) (Ti_{1-y}Zr_{y})O₃ (0<x<1, 0<y<1) and Ba (Ti_{1-y}Zr_{y}) O₃ (0<y<1), in which calcium (Ca), zirconium (Zr), or the like is partially dissolved into BaTiO₃, but the present disclosure is not limited thereto.

The dielectric layer 140 may include one or more of a ceramic additive, an organic solvent, a plasticizer, a binder, and a dispersant. The ceramic additive may be, for example, a transition metal oxide or a carbide, a rare-earth element, magnesium (Mg), aluminum (Al), or the like.

The first internal electrode 150 and the second internal electrode 160 may be alternately stacked, with the dielectric layer 140 interposed therebetween. The stacked structure may be repeated within the body 110, and the internal electrode closest to the fifth surface S5 of the body 110 may be the first internal electrode 150 or the second internal electrode 160. Similarly, the internal electrode closest to the sixth surface S6 of the body 110 may be the first internal electrode 150 or the second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may each be formed by printing a conductive paste that includes a metal on a surface of the dielectric layer 140. For example, the internal electrode may be formed by printing a conductive paste that contains nickel (Ni) or a nickel (Ni) alloy on the surface of the dielectric layer 140 using screen printing or gravure printing. However, the present embodiment is not limited thereto.

When a voltage is applied to the first external electrode 200 and the second external electrode 300, charges accumulate between the first internal electrode 150 and the second internal electrode 160. That is, capacitance of the multilayer ceramic capacitor 1000 may be obtained between the first internal electrode 150 electrically connected to the first external electrode 200 and the second internal electrode 160 electrically connected to the second external electrode 300. The capacitance of the multilayer ceramic capacitor 1000 is proportional to an overlapping area of the first internal electrode 150 and the second internal electrode 160, which overlap each other in the thickness direction (T-axis direction).

Referring to FIG. 5 and FIG. 6, a first cover layer 143 and a second cover layer 145 may be disposed on the outermost side of the body 110 in the thickness direction (T-axis direction).

The first cover layer 143 is disposed between the fifth surface S5 of the body 110 and the internal electrode closest thereto. The second cover layer 145 is disposed between the sixth surface S6 of the body 110 and the internal electrode closest thereto.

That is, the first cover layer 143 may be disposed on an upper portion of the uppermost internal electrode in the body 110, and the second cover layer 145 may be disposed on a lower portion of the lowermost internal electrode. The first cover layer 143 and the second cover layer 145 may have the same composition as the dielectric layer 140. The first cover layer 143 and the second cover layer 145 may be formed by stacking one or more dielectric layers on the outer surface of the uppermost internal electrode and the outer surface of the lowermost internal electrode, respectively. Meanwhile, the first cover layer 143 and the second cover layer 145 may have different compositions from the dielectric layer 140.

The first cover layer 143 and the second cover layer 145 may serve to prevent damage to the first internal electrode 150 and the second internal electrode 160 due to physical or chemical stress.

The first external electrode 200 and the second external electrode 300 are disposed on an outer surface of the body 110.

The first external electrode 200 may be disposed on the first surface S1 of the body 110 and may extend onto the third surface S3, the fourth surface S4, the fifth surface S5, and the sixth surface S6. The second external electrode 300 may be disposed on the second surface S2 of the body 110 and may extend onto the third surface S3, the fourth surface S4, the fifth surface S5, and the sixth surface S6.

In other embodiments, the first external electrode 200 and the second external electrode 300 may extend onto a part of at least one of the fifth surface S5 and the sixth surface S6.

The first external electrode 200 may include a first electrode layer 120, a first plating layer 180 and a second plating layer 182.

The first electrode layer 120 includes a first connection portion 121, a first band portion 123, and a first edge portion 125.

The first connection portion 121 covers the first surface S1 of the body 110 and is electrically connected to a plurality of first internal electrodes 150.

In other embodiments, the first connection portion 121 may cover a portion of the first surface S1 of the body 110.

The first band portion 123 extends from the first connection portion 121 to cover at least a portion of the third surface S3, the fourth surface S4, the fifth surface S5, and the sixth surface S6 of the body 110. The first band portion 123 may allow the first electrode layer 120 to be more strongly adhered to the body 110.

The first edge portion 125 may be a portion that connects the first connection portion 121 and the first band portion 123.

The second external electrode 300 may include a second electrode layer 130, a third plating layer 190, and a fourth plating layer 192.

The second electrode layer 130 includes a second connection portion 131, a second band portion 133, and a second edge portion 135.

The second connection portion 131 covers the second surface S2 of the body 110 and is electrically connected to a plurality of second internal electrodes 160.

In other embodiments, the second connection portion 131 may cover a portion of the second surface S2 of the body 110.

The second band portion 133 extends from the second connection portion 131 to cover at least a portion of the third surface S3, the fourth surface S4, the fifth surface S5, and the sixth surface S6 of the body 110. The second band portion 133 may allow the second electrode layer 130 to be more strongly adhered to the body 110.

The second edge portion 135 may be a portion that connects the second connection portion 131 and the second band portion 133.

Based on an optical microscope or scanning electron microscope (SEM) photograph of a cross section taken in the length direction (L-axis direction)-thickness direction (T axis direction) at the center of the multilayer ceramic capacitor 1000 in the width direction (W-axis direction), in the multilayer ceramic capacitor 1000 shown in the above-described cross-sectional photograph, the first connection portion 121 and the second connection portion 131 may have a shape substantially parallel to the thickness direction (T-axis direction), the first band portion 123 and the second band portion 133 may have a shape substantially parallel to the length direction (L-axis direction), and the first edge portion 125 and the second edge portion 135 may have a curved line shape. The above-described curved line shape may be a curved line shape having a tangent whose slope changes from a direction parallel to the thickness direction (T-axis direction) to a direction parallel to the length direction (L-axis direction) (or in opposite directions).

The first electrode layer 120 and the second electrode layer 130 may be formed of a conductive material comprising at least one selected from the group consisting of such as copper (Cu), aluminum (Al), silver (Ag), tin (Sn), gold (Au), nickel (Ni), lead (Pb), chromium (Cr), titanium (Ti), and an alloy thereof, but is not limited thereto.

As another example, the first electrode layer 120 and the second electrode layer 130 may include a metal and glass. For example, the metal may be a conductive metal including at least one selected from the group consisting of copper (Cu), nickel (Ni), tin (Sn), palladium (Pd), platinum (Pt), gold (Au), silver (Ag), tungsten (W), titanium (Ti), lead (Pb), and an alloy thereof. The glass component included in the electrode layer may be a composition mixed with oxides. The glass component may include, for example, at least one selected from the group consisting of a silicon oxide, a boron oxide, an aluminum oxide, a transition metal oxide, an alkali metal oxide, an alkaline-earth metal oxide, and a combination thereof. Here, the transition metal may be selected from the group consisting of zinc (Zn), titanium (Ti), copper (Cu), vanadium (V), manganese (Mn), iron (Fe), and nickel (Ni), the alkali metal may be selected from the group consisting of lithium (Li), sodium (Na), and potassium (K), and the alkaline-earth metal may be selected from the group consisting of magnesium (Mg), calcium (Ca), strontium (Sr), and barium (Ba). The method of forming the electrode layer may not be particularly limited. For example, it may be formed by dipping a body into a conductive paste containing metal and glass, or by printing a conductive paste on a surface of a body by, e.g., screen printing or gravure printing method. In addition, various methods, such as, applying a conductive paste on the surface of a body or transferring a dry film formed by drying a conductive paste to a laminate, may be used.

The first plating layer 180 may cover the first electrode layer 120, and the second plating layer 182 may cover the first plating layer 180. The first plating layer 180 may include nickel (Ni) and the second plating layer 182 may include tin (Sn).

The third plating layer 190 may cover the second electrode layer 130 and the fourth plating layer 192 may cover the third plating layer 190. The third plating layer 190 may include nickel (Ni) and the fourth plating layer 192 may include tin (Sn). The third plating layer 190 and the fourth plating layer 192 correspond to the first plating layer 180 and the second plating layer 182 except for their locations, and therefore the following description will mainly refer to the first plating layer 180 and the second plating layer 182.

The first plating layer 180 may include at least one crystal grain. In some embodiments, the first plating layer 180 may include a plurality of crystal grains.

An average ratio of the major and minor axes of the crystal grain of the first plating layer 180 may be 1:1 or more and 3:1 or less. In this case, the influence of hydrogen that is inevitably generated during the plating process may be minimized, thereby improving insulation resistance.

If the average ratio of the major and minor axes of the crystal grain of the first plating layer 180 exceeds 3:1, the hydrogen penetration suppression effect of the first plating layer 180 may be insufficient. Meanwhile, the major axis of the crystal grain represent the maximum dimension of the crystal grain, and the minimum value (i.e., lower limit) of the average ratio of the major and minor axes of the crystal grain is 1:1.

The major axis of the crystal grain represents the maximum dimension (i.e., a maximum grain diameter) penetrating the interior of the crystal grain, and the minor axis of the crystal grain represents the dimension measured in a direction perpendicular to the major axis. However, if there are two or more maximum dimensions having the same length and penetrating the interior of the crystal grain, any one of the two or more maximum dimensions may be regarded as the major axis and the minor axis may be measured in the same manner as the method described above.

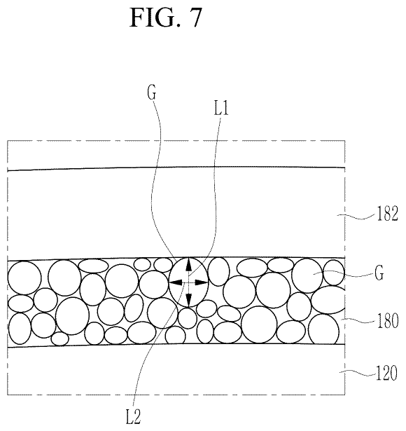

FIG. 7 is an enlarged cross-sectional view of region A of FIG. 5.

Referring to FIG. 7, it is possible to obtain an average ratio (L1:L2) of major and minor axes of a crystal grain G in the first plating layer 180 by measuring the major axis L1 which is the maximum dimension penetrating the interior of the crystal grain G, and the minor axis L2 which is the dimension measured in a direction perpendicular to the measurement direction of the major axis L1.

Here, the major and minor axes of the crystal grain may be obtained by image-scanning and measuring the length direction (L-axis direction)-thickness direction (T-axis direction) cross-section of the central portion of the multilayer ceramic capacitor in the width direction (W-axis direction) using a scanning electron microscope (SEM). For example, it is possible to obtain the average ratio of the major and minor axes of the crystal grain by measuring the major and minor axes of each of ten largest crystal grains included in the first plating layer in an order of their sizes when the cross section is captured using the scanning electron microscope (SEM), and then obtaining the average ratio value of the major and minor axes.

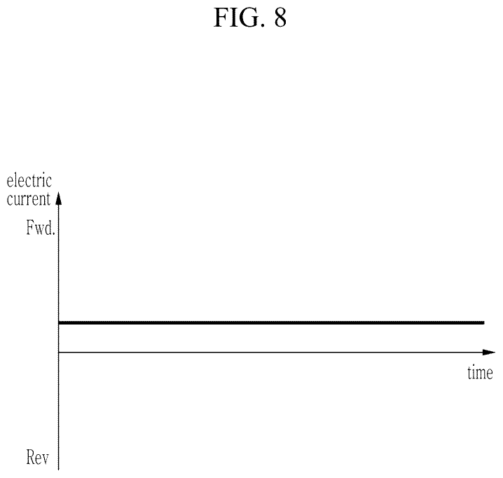

FIG. 8 is a schematic view of a current application profile of a direct current (DC) plating method.

Referring to FIG. 8, during the manufacturing process of the multilayer ceramic capacitor, when nickel (Ni) plating and/or tin (Sn) plating is performed on the external electrode, a constant current is applied for a set period of time. In this case, there is a problem of insulation resistance degradation because the hydrogen that generates accompanying the plating reaction continuously penetrates into the interior of the multilayer ceramic capacitor during the plating period.

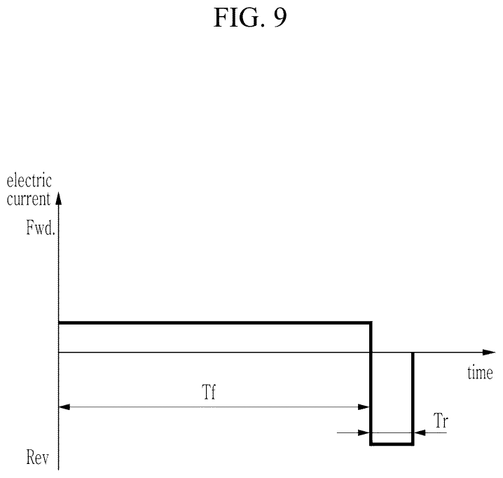

FIG. 9 is a schematic view showing the current application profile of a pulse periodic reverse current (PPR) plating method.

Referring to FIG. 9, although hydrogen may be adsorbed during forward current application time when the plating is performed, the adsorbed hydrogen is desorbed during reverse current application time, and thus the hydrogen cannot easily penetrate into the interior of the multilayer ceramic capacitor during the plating process. Therefore, hydrogen accumulation can be reduced compared to the case when applying the DC plating method.

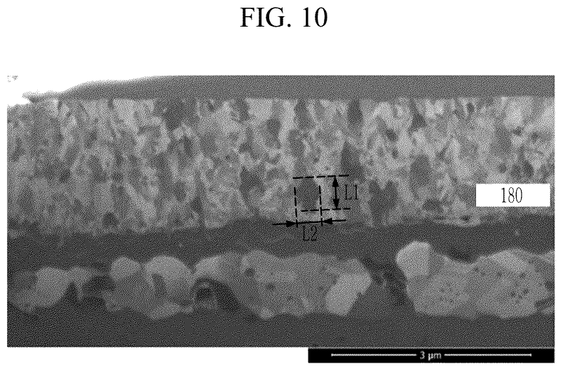

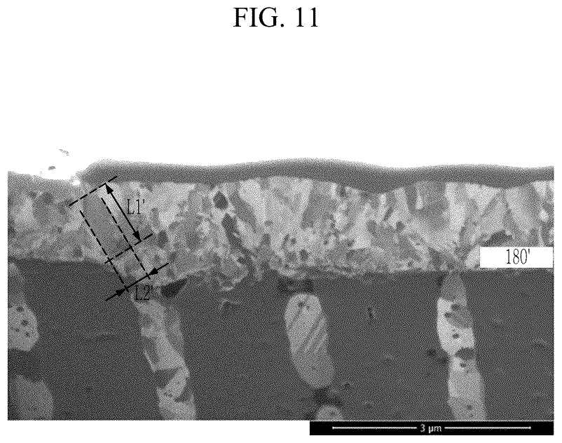

FIG. 10 is an electron microscope photograph of a first plating layer formed by the PPR plating method, and FIG. 11 an electron microscope photograph of a first plating layer formed by the DC plating method.

Referring to FIG. 10, the first plating layer 180 formed by applying the PPR plating method has round-shaped crystal grains. Referring to FIG. 11, the first plating layer 180′ formed by applying the DC plating method has needle-shaped crystal grains with a pointed shape. That is, a ratio of a major axis L1 to a minor axis L2 of the crystal grain shown in FIG. 10 is smaller than a ratio of a major axis L1′ to a minor axis L2′ of the crystal grain shown in FIG. 11.

Hereinafter, the conditions for PPR plating will be described. The PPR plating may include, as shown in FIG. 9, a forward current and a reverse current and may include one or more reverse currents in a waveform. Since the PPR plating method includes one or more reverse currents, it necessarily includes a hydrogen desorption process. Therefore, the PPR plating method may better suppress hydrogen accumulation during the plating process compared to the DC plating method.

The process of forming the first plating layer may be barrel plating, and the rotation speed of the barrel may be 5 rpm or more and 30 rpm or less. If the rotation speed of the barrel is less than 5 rpm or more than 30 rpm, chips may adhere to each other or problems may occur in a thickness distribution of the plating layer. The forward current may have density of 0.5 ampere per square decimeter (ASD) to 20 ASD, and the reverse current may have density of 0.1 ASD to 20 ASD.

The ratio Tf/Tr of forward current time Tf to reverse current time Tr may be 2 or more and 50 or less. If the ratio Tf/Tr is less than 2, loss of the external electrode may occur, and if the ratio Tf/Tr exceeds 50, the hydrogen penetration suppression effect may be insufficient.

Meanwhile, the intensity of the reverse current may be greater than that of the forward current.

By forming the first plating layer to meet the conditions described above, the present embodiment helps control the shape of crystal grains of the first plating layer and secure high temperature reliability by suppressing hydrogen penetration.

Referring to FIG. 9, the PPR plating may be performed continuously until the plating is completed, and may be performed without separate off-time for setting the current to “zero” until the plating is completed.

An average thickness of the first plating layer 180 may be 1.806 μm or more and 2.2362 μm or less.

If the average thickness of the first plating layer 180 is less than 1.806 μm, plating layer breaks may occur, resulting in poor reliability, and if the average thickness of the first plating layer 180 exceeds 2.2362 μm, the size of the multilayer ceramic capacitor may exceed the specification.

Here, the average thickness of the first plating layer can be obtained by image-scanning and measuring the length direction (L-axis direction)-thickness direction (T-axis direction) cross-section at a center of the multilayer ceramic capacitor in the width direction (W-axis direction) using scanning electron microscope (SEM). For example, it is possible to obtain the average thickness of the first plating layer by measuring thicknesses of ten equally spaced points on the first plating layer shown in the above-described cross-sectional photograph, and then obtaining the arithmetic average of the measured thicknesses.

The standard deviation of the thickness of the first plating layer 180 may be 0.24 or more and 0.35 or less. The standard deviation of the thickness of the first plating layer 180 may be derived from the average thickness of the first plating layer mentioned above.

If the standard deviation of the thickness of the first plating layer 180 exceeds 0.35, the size deviation of the multilayer ceramic capacitor may increase, resulting in a lack of quality consistency or the size of the multilayer ceramic capacitor may exceed the specification.

A coefficient of variation (CV) of the thickness of the first plating layer 180 may be 11.7% or more and 15.9% or less. Here, the coefficient of variation of thickness may refer to a value obtained by dividing the standard deviation of thickness by the arithmetic average value of thickness.

If the variation coefficient of the thickness of the first plating layer 180 exceeds 15.9%, the size deviation of the multilayer ceramic capacitor may increase, result in a lack of quality consistency or the size of the multilayer ceramic capacitor may exceed the specification.

Meanwhile, a surface roughness Ra of the first plating layer 180 may be 1.51 μm or more and 1.86 μm or less.

If the surface roughness of the first plating layer 180 is less than 1.51 μm, the bonding strength between the plating layers may be insufficient, and if the surface roughness of the first plating layer 180 exceeds 1.86 μm, the plating layers may become uneven when forming additional plating layers.

Here, the surface roughness of the first plating layer can be obtained by image-scanning the length direction (L-axis direction)-thickness direction (T-axis direction) cross-section at a center of the multilayer ceramic capacitor in the width direction (W-axis direction) using an SEM. For example, the surface roughness of the first plating layer may refer to values including the minimum and maximum values of surface roughness measured at ten equally spaced points on the first plating layer shown in the cross-section photograph mentioned above.

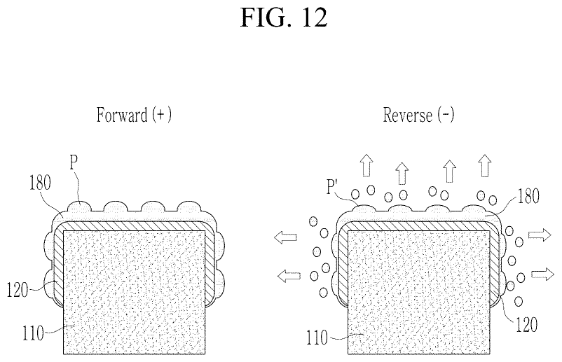

FIG. 12 is a schematic view that shows a plating layer smoothing process by PPR plating.

Referring to FIG. 12, protrusions P generated by Forward (+) current on the first plating layer 180 covering the first electrode layer 120 are etched by Reverse (−) current into smaller protrusions P′, so that the surface of the first plating layer 180 can be smoothed.

Hereinafter, specific embodiments of the present disclosure will be described. However, the embodiments described below are only intended to specifically illustrate or describe the disclosure, and the scope of the disclosure should not be limited thereby.

### Preparation Example: Manufacture of Multilayer Ceramic Capacitor

### Example

A paste containing barium titanate (BaTiO₃) powder was applied on a carrier film and dried to manufacture a plurality of dielectric green sheets.

A conductive paste containing nickel (Ni) was applied onto the dielectric green sheet using screen printing to form a conductive paste layer.

A plurality of dielectric green sheet was stacked such that at least portions of the conductive paste layers overlap each other, to manufacture a dielectric green sheet laminate.

After cutting the dielectric green sheet laminate into individual chips, the debinding was performed by maintaining the individual chips at 350° C. for 66 hours in an air atmosphere, and firing was performed at 1165° C. to manufacture a body.

A paste containing glass frit and copper (Cu) was applied to an outer surface of the body by dipping, dried, and then fired to form an electrode layer.

PPR plating was used to perform nickel (Ni) plating on the electrode layer to form a first plating layer.

Thereafter, heat treatment was performed at 160° C. for 2 hours to manufacture a multilayer ceramic capacitor.

In order to confirm the shape of crystal grains of the first plating layer of the multilayer ceramic capacitor according to Example, a specimen was prepared to reveal a length direction (L-axis direction)-thickness direction (T-axis direction) cross-section. Next, after etching the surface of the specimen with a focused ion beam (FIB) machine, the major and minor axes of the crystal grains of the first plating layer were measured using an SEM at 30 kV, 50,000× magnification, and SE MODE. Here, ten largest crystal grains were selected in an order of their sizes, and the major and minor axes of the ten crystal grains were measured, and the arithmetic average value of the ratio of the major and minor axes was taken, which is shown in Table 1.

TABLE 1

| | Major | Minor | Major axis/ | |
|---|---|---|---|---|
| | axis (μm) | axis(μm) | Minor axis | Major axis:Minor axis |
| Crystal | 0.80 | 0.32 | 2.49 | 2.49:1 |
| grain 1 | | | | |
| Crystal | 0.58 | 0.32 | 1.81 | 1.81:1 |
| grain 2 | | | | |
| Crystal | 0.88 | 0.20 | 4.37 | 4.37:1 |
| grain 3 | | | | |
| Crystal | 0.54 | 0.28 | 1.89 | 1.89:1 |
| grain 4 | | | | |
| Crystal | 0.56 | 0.37 | 1.54 | 1.54:1 |
| grain 5 | | | | |
| Crystal | 0.46 | 0.48 | 0.96 | 0.96:1 |
| grain 6 | | | | |
| Crystal | 0.71 | 0.29 | 2.44 | 2.44:1 |
| grain 7 | | | | |
| Crystal | 0.32 | 0.24 | 1.33 | 1.33:1 |
| grain 8 | | | | |
| Crystal | 0.31 | 0.33 | 0.95 | 0.95:1 |
| grain 9 | | | | |
| Crystal | 0.72 | 0.36 | 1.97 | 1.97:1 |
| grain 10 | | | | |
| Average | 0.59 | 0.32 | 1.97 | 1.97:1 |

Referring to Table 1, the average major axis of the crystal grains of the first plating layer of the multilayer ceramic capacitor according to Example was 0.59 μm, the average minor axis was 0.32 μm, and the average ratio of the major axis to the minor axis was 1.97:1. As can be seen, the difference between the major and minor axes of the crystal grains of the first plating layer of the multilayer ceramic capacitor according to Example was relatively small, and thus the crystal grains exhibited a rounded shape.

### Comparative Example

The method of manufacturing the multilayer ceramic capacitor was the same as Example, except that DC plating was used to perform nickel (Ni) plating on the electrode layer to form a first plating layer.

In order to confirm the shape of crystal grains of the first plating layer of the multilayer ceramic capacitor according to Comparative Example, a specimen was prepared to reveal a length direction (L-axis direction)-thickness direction (T-axis direction) cross-section. Next, after etching the surface of the specimen with FIB machine, the major and minor axes of the crystal grains of the first plating layer were measured using an SEM at 30 kV, 50,000× magnification, and SE MODE. Here, ten largest crystal grains were selected in an order of their sizes, and the major and minor axes of the ten crystal grains were measured, and the arithmetic average value of the ratio of the major and minor axes was taken, which is shown in Table 2.

TABLE 2

| | Major | Minor | Major axis/ | |
|---|---|---|---|---|
| | axis (μm) | axis (μm) | Minor axis | Major axis:Minor axis |
| Crystal | 1.15 | 0.47 | 2.45 | 2.45:1 |
| grain 1 | | | | |
| Crystal | 1.38 | 0.12 | 11.66 | 11.66:1 |
| grain 2 | | | | |
| Crystal | 1.38 | 0.17 | 7.95 | 7.95:1 |
| grain 3 | | | | |
| Crystal | 1.21 | 0.26 | 4.61 | 4.61:1 |
| grain 4 | | | | |
| Crystal | 1.31 | 0.35 | 3.74 | 3.74:1 |
| grain 5 | | | | |
| Crystal | 1.25 | 0.20 | 6.22 | 6.22:1 |
| grain 6 | | | | |
| Crystal | 1.04 | 0.18 | 5.95 | 5.95:1 |
| grain 7 | | | | |
| Crystal | 1.14 | 0.20 | 5.67 | 5.67:1 |
| grain 8 | | | | |
| Crystal | 0.92 | 0.33 | 2.80 | 2.80:1 |
| grain 9 | | | | |
| Crystal | 1.00 | 0.21 | 4.71 | 4.71:1 |
| grain 10 | | | | |
| Average | 1.18 | 0.25 | 5.58 | 5.58:1 |

Referring to Table 2, the average major axis of the crystal grains of the first plating layer of the multilayer ceramic capacitor according to Comparative Example was 1.18 μm, the average minor axis was 0.25 μm, and the average ratio of the major axis to the minor axis was 5.58:1. As can be seen, the difference between the major and minor axes of the crystal grains of the first plating layer of the multilayer ceramic capacitor according to Comparative Example was relatively large, and thus the crystal grains exhibited a pointed shape.

### Experimental Example 1: Evaluation of Insulation Resistance Reliability at High Temperature

After substrates mounted with multilayer ceramic capacitors according to Example and Comparative Example were immersed in a 0.01 M sodium hydroxide (NaOH) solution, a DC plating condition of Comparative Example was then set to satisfy 0.03 A, and a PPR plating condition of Example was set to satisfy a forward current (Fwd.) of 0.03 A and 450 ms, and a reverse current (Rev.) of 0.09 A and 50 ms, thereby inducing only a hydrogen reaction.

A waveform of PPR plating was applied to the substrate on which the multilayer ceramic capacitor according to Example was mounted, and all 50 samples showed normal insulation resistance.

A waveform of DC plating was applied to the substrate on which the multilayer ceramic capacitor according to Comparative Example was mounted, and most of the 50 samples showed an insulation resistance drop (IR drop).

### Experimental Example 2: Reproducibility Evaluation

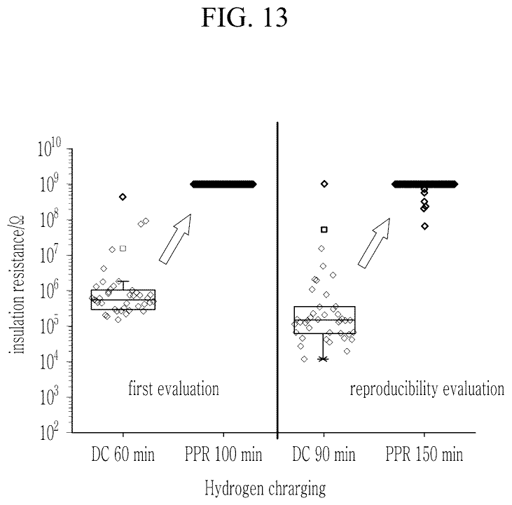

Meanwhile, the plating time of Experimental Example 1 was further extended to evaluate reproducibility, and the results are shown in FIG. 13. For Comparative Example and Example, the same result (right side of FIG. 13) as the first evaluation result (left side of FIG. 13) was obtained.

### Experimental Example 3: Thickness of Plating Layer

The thickness of the first plating layers of five representative samples of multilayer ceramic capacitors according to Example and Comparative Example were measured, and the average, standard deviation, and coefficient of variation were derived. The results are shown in Table 3 and Table 4. Table 3 shows the results for Example and Table 4 shows the results for Comparative Example.

TABLE 3

| Measurement | Sam- | Sam- | Sam- | Sam- | Sam- |
|---|---|---|---|---|---|
| point | ple 1 | ple 2 | ple 3 | ple 4 | ple 5 |
| 1 | 1.76 | 1.7 | 1.78 | 2.23 | 2.40 |
| 2 | 2.37 | 1.98 | 1.80 | 2.01 | 1.85 |
| 3 | 2.28 | 1.58 | 2.25 | 2.22 | 2.29 |
| 4 | 2.9 | 1.92 | 2.56 | 1.71 | 1.90 |
| 5 | 2.19 | 1.87 | 2.04 | 2.02 | 2.13 |
| 6 | 1.82 | 1.35 | 1.79 | 2.57 | 2.54 |
| 7 | 2.09 | 1.74 | 1.94 | 2.29 | 2.98 |
| 8 | 2.24 | 1.74 | 2.10 | 1.59 | 1.84 |
| 9 | 2.08 | 2.32 | 2.02 | 1.73 | 2.11 |
| 10 | 2.59 | 1.86 | 2.08 | 1.98 | 2.33 |
| Average | 2.232 | 1.806 | 2.0372 | 2.035 | 2.2362 |
| Standard | 0.34 | 0.26 | 0.24 | 0.30 | 0.35 |
| deviation | | | | | |
| Coefficient of | 15.2% | 14.2% | 11.7% | 14.9% | 15.9% |
| variation | | | | | |

TABLE 4

| Measurement | Sam- | Sam- | Sam- | Sam- | Sam- |
|---|---|---|---|---|---|
| point | ple 1 | ple 2 | ple 3 | ple 4 | ple 5 |
| 1 | 1.3 | 1.87 | 2.45 | 1.5 | 2.57 |
| 2 | 1.54 | 1.77 | 2.26 | 1.93 | 1.53 |
| 3 | 1.67 | 1.68 | 0.67 | 1.6 | 2.05 |
| 4 | 1.7 | 2.22 | 2.52 | 1.86 | 2.26 |
| 5 | 1.81 | 2.01 | 1.84 | 1.34 | 2.05 |
| 6 | 1.73 | 1.39 | 2.43 | 1.11 | 1.76 |
| 7 | 1.5 | 1.51 | 2.41 | 1.74 | 1.78 |
| 8 | 2.24 | 1.71 | 1.66 | 1.6 | 1.75 |
| 9 | 1.38 | 1.66 | 1.89 | 1.8 | 1.86 |
| 10 | 1.97 | 1.8 | 2.57 | 0.84 | 1.69 |
| Average | 1.684 | 1.762 | 2.07 | 1.532 | 1.93 |
| Standard | 0.28 | 0.24 | 0.59 | 0.35 | 0.31 |
| deviation | | | | | |
| Coefficient | 16.6% | 13.5% | 28.3% | 22.7% | 16.0% |
| of variation | | | | | |

Referring to Table 3, the coefficient of variation of the thickness of the first plating layer of the multilayer ceramic capacitor according to Example was 11.7% or more and 15.9% or less. Referring to Table 4, the coefficient of variation of the thickness of the first plating layer of the multilayer ceramic capacitor according to Comparative Example was 13.5% or more and 28.3% or less. It can be seen that the coefficient of variation of the thickness of the first plating layer of the multilayer ceramic capacitor according to Example has a smaller range, and therefore the dispersion of the plating thickness is improved.

### Experimental Example 4: Surface Roughness of Plating Layer

The surface roughness of the first plating layers of five representative samples of the multilayer ceramic capacitors according to Example and Comparative Example was measured, and the results are shown in Table 5 and Table 6, respectively. Table 5 shows the results for Example and Table 6 shows the results for Comparative Example.

TABLE 5

Surface roughness (μm)

| Measurement | Sam- | Sam- | Sam- | Sam- | Sam- |
|---|---|---|---|---|---|
| point | ple 1 | ple 2 | ple 3 | ple 4 | ple 5 |
| 1 | 1.51 | 1.73 | 1.68 | 1.81 | 1.68 |
| 2 | 1.74 | 1.63 | 1.63 | 1.76 | 1.63 |
| 3 | 1.75 | 1.69 | 1.82 | 1.7 | 1.63 |
| 4 | 1.7 | 1.65 | 1.76 | 1.63 | 1.74 |
| 5 | 1.59 | 1.8 | 1.74 | 1.83 | 1.74 |
| 6 | 1.57 | 1.69 | 1.86 | 1.71 | 1.76 |
| 7 | 1.64 | 1.66 | 1.76 | 1.67 | 1.7 |
| 8 | 1.7 | 1.61 | 1.82 | 1.6 | 1.67 |
| 9 | 1.75 | 1.77 | 1.6 | 1.85 | 1.67 |
| 10 | 1.66 | 1.8 | 1.85 | 1.72 | 1.75 |
| Average | 1.698 | 1.709 | 1.765 | 1.685 | 1.718 |
| Maximum | 1.75 | 1.8 | 1.86 | 1.85 | 1.76 |
| value | | | | | |
| Minimum | 1.51 | 1.61 | 1.6 | 1.6 | 1.63 |
| value | | | | | |

TABLE 6

Surface roughness (μm)

| Measurement | Sam- | Sam- | Sam- | Sam- | Sam- |
|---|---|---|---|---|---|
| point | ple 1 | ple 2 | ple 3 | ple 4 | ple 5 |
| 1 | 2.68 | 2.72 | 2.96 | 2.87 | 2.74 |
| 2 | 2.71 | 2.57 | 2.9 | 2.95 | 2.66 |
| 3 | 2.7 | 2.58 | 2.96 | 2.92 | 2.62 |
| 4 | 2.62 | 2.59 | 3 | 2.86 | 2.64 |
| 5 | 2.8 | 2.76 | 2.99 | 2.96 | 2.68 |
| 6 | 2.75 | 2.61 | 3.04 | 2.86 | 2.6 |
| 7 | 2.46 | 2.71 | 2.66 | 2.83 | 2.66 |
| 8 | 2.82 | 2.76 | 2.77 | 2.77 | 2.7 |
| 9 | 2.82 | 2.68 | 2.8 | 3.06 | 2.63 |
| 10 | 2.7 | 2.54 | 2.95 | 2.95 | 2.66 |
| Average | 2.658 | 2.654 | 2.899 | 2.887 | 2.669 |
| Maximum value | 2.82 | 2.76 | 3.04 | 3.06 | 2.74 |
| Minimum value | 2.46 | 2.54 | 2.66 | 2.77 | 2.6 |

Referring to Table 5, the surface roughness of the first plating layer of the multilayer ceramic capacitor according to Example was 1.51 μm or more and 1.86 μm or less. Referring to Table 6, the surface roughness of the first plating layer of the multilayer ceramic capacitor according to Comparative Example was 2.46 μm or more and 3.06 μm or less. Since the surface roughness of the first plating layer of the multilayer ceramic capacitor according to Example has a smaller range, it can be seen that the smoothness of the plating layer is improved in Example.

While this disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

1000: multilayer ceramic capacitor
110: body
200: first external electrode
300: second external electrode
120: first electrode layer
130: second electrode layer
140: dielectric layer
143: first cover layer
145: second cover layer
150: first internal electrode
160: second internal electrode
180: first plating layer
182: second plating layer
190: third plating layer
192: fourth plating layer

What is claimed is:

1. A multilayer ceramic capacitor comprising:
a body including a plurality of internal electrodes stacked with a dielectric layer interposed therebetween; and
an external electrode disposed outside the body and connected to the plurality of internal electrodes,
wherein the external electrode includes a first plating layer,
the first plating layer includes a crystal grain,
an average ratio of a major axis to a minor axis of the crystal grain of the first plating layer is 1:1 or more and 3:1 or less, and
a coefficient of variation of a thickness of the first plating layer is 11.7% or more and 15.9% or less.

2. The multilayer ceramic capacitor of claim 1, wherein:
an average thickness of the first plating layer is 1.806 μm or more and 2.2362 μm or less.

3. The multilayer ceramic capacitor of claim 2, wherein:
a standard deviation of the thickness of the first plating layer is 0.24 or more and 0.35 or less.

4. The multilayer ceramic capacitor of claim 1, wherein:
the first plating layer contains nickel (Ni).

5. The multilayer ceramic capacitor of claim 1, wherein:
the major axis represents a maximum dimension of the crystal grain, and
the minor axis represents a dimension of the crystal grain, measured in a direction perpendicular to a measurement direction of the major axis.

6. The multilayer ceramic capacitor of claim 1, further comprising a second plating layer disposed on the first plating layer.

7. The multilayer ceramic capacitor of claim 6, wherein:
the second plating layer contains tin (Sn).

8. The multilayer ceramic capacitor of claim 1, wherein:
the external electrode further comprises an electrode layer disposed between the body and the first plating layer and connected to the internal electrode.

9. A multilayer ceramic capacitor comprising:
a body including a plurality of internal electrodes stacked with a dielectric layer interposed therebetween; and
an external electrode disposed outside the body and connected to the plurality of internal electrodes,
wherein the external electrode includes a first plating layer,
the first plating layer includes a grain,
an average ratio of a major axis to a minor axis of the grain of the first plating layer is 1:1 or more and 3:1 or less, and
a surface roughness of the first plating layer is 1.51 μm or more and 1.86 μm or less.

10. The multilayer ceramic capacitor of claim 9, wherein:
the first plating layer contains nickel (Ni).

11. The multilayer ceramic capacitor of claim 9, wherein:
the major axis of the crystal grain represents a maximum dimension of the crystal grain, and
the minor axis represents a dimension of the crystal grain, measured in a direction perpendicular to a measurement direction of the major axis.

12. The multilayer ceramic capacitor of claim 9, further comprising a second plating layer disposed on the first plating layer.

13. The multilayer ceramic capacitor of claim 12, wherein:
the second plating layer contains tin (Sn).

14. The multilayer ceramic capacitor of claim 9, wherein:
the external electrode further comprises an electrode layer disposed between the body and the first plating layer and connected to the internal electrode.
